(19) United States
(12) Patent Application Publication
(10) Pub. No.: US 2017/0133183 A1
(43) Pub. Date: May 11, 2017

(54) ELECTROMAGNETIC RELAY AND COIL TERMINAL

(71) Applicant: FUJITSU COMPONENT LIMITED, Tokyo (JP)

(72) Inventors: Yoichi HASEGAWA, Tokyo (JP); Daiei IWAMOTO, Tokyo (JP)

(73) Assignee: FUJITSU COMPONENT LIMITED, Tokyo (JP)

(21) Appl. No.: 15/322,282

(22) PCT Filed: May 12, 2015
(86) PCT No.: PCT/JP2015/063672

§ 371 Date: Dec. 27, 2016

(30) Foreign Application Priority Data
Jul. 28, 2014 (JP) 2014-152869

(51) Int. Cl. H01H 50/14; H01H 50/38; H01H 50/02; H01H 50/56

(52) U.S. Cl. CPC H01H 50/14; H01H 50/56; H01H 50/38; H01H 50/02

(57) ABSTRACT

An electromagnetic relay includes: a base; a pair of fixed contact terminals, each including a fixed contact and a first fulcrum fixed to the base; a movable contact spring including a pair of movable pieces, each of the movable pieces including a movable contact contacting and separating from the fixed contact; an armature that is coupled with the movable contact spring, by a rotary motion around a second fulcrum; an electromagnetic device that drives the armature; and a permanent magnet arranged between the pair of fixed contact terminals and between the pair of movable pieces to generate a magnetic field. The first fulcrum and the second fulcrum are arranged mutually in opposite directions with respect to the movable contact or the fixed contact.

### TECHNICAL FIELD

The present invention relates to an electromagnetic relay and a coil terminal.

### BACKGROUND ART

There has been known an electromagnetic relay in which a permanent magnet for extinguishing a magnetic arc generates a magnetic flux between relay contacts and an arc generated between the relay contacts is extended by Lorentz force and extinguished. For example, each of electromagnetic relays of Patent Documents 1-4 is known as an electromagnetic relay including a plurality of permanent magnets for extinguishing the magnetic arc. Moreover, each of electromagnetic relays of Patent Documents 2, 3 and 5-7 is known as an electromagnetic relay extending the arc in a single direction.

### PRIOR ART DOCUMENT

### [Patent Document 1] Japanese Laid-open Patent Publication No. 2013-196783

### [Patent Document 2] Japanese Patent No. 5085754

### [Patent Document 3] Japanese Patent No. 4810937

### [Patent Document 4] Japanese Laid-open Patent Publication No. 2000-67725

### [Patent Document 5] Japanese Patent No. 5202072

### [Patent Document 6] Utility Model Application Laid-Open Publication No. 63-157143

### [Patent Document 7] Japanese Laid-open Patent Publication No. 10-326553

### SUMMARY OF THE INVENTION

Each of electromagnetic relays of above-mentioned Patent Documents 1-4 includes the plurality of permanent magnets for extinguishing the magnetic arc, and therefore there is a problem that a manufacturing cost increases, compared with an electromagnetic relay including a single permanent magnet for extinguishing the magnetic arc.

Each of electromagnetic relays of above-mentioned Patent Documents 2, 3 and 5-7 extends the arc in a single direction. However, the arc may not be extended effectively according to the direction of a current flowing between a fixed contact and a movable contact. That is, in each of the electromagnetic relays of above-mentioned Patent Documents 2, 3 and 5-7, there is a problem that a difference occurs in an extinguishing capability of the arc according to the direction of the current flowing between the movable contact and the fixed contact.

It is an object of the present invention to provide an electromagnetic relay and a coil terminal that can extinguish the arc effectively regardless of the direction of the current flowing between the movable contact and the fixed contact, and reduce the manufacturing cost.

To achieve the above-mentioned object, an electromagnetic relay disclosed herein characterized by comprising: a base; a pair of fixed contact terminals each including a fixed contact and a first fulcrum fixed to the base; a movable contact spring including a pair of movable pieces, each of the movable pieces including a movable contact contacting and separating from the fixed contact; an armature that is coupled with the movable contact spring, and moves the movable contact spring by a rotary motion around a second fulcrum; an electromagnetic device that drives the armature; and a permanent magnet that is arranged between the pair of fixed contact terminals and between the pair of movable pieces, and generates a magnetic field; wherein the first fulcrum and the second fulcrum are arranged mutually in opposite directions with respect to the movable contact or the fixed contact.

A coil terminal disclosed herein that is formed by bending a piece of metal plate characterized by comprising: a vertical portion that restricts the movement of the coil terminal in a horizontal direction; a horizontal portion that restricts the movement of the coil terminal in a vertical direction; a leg portion that extends vertically downward from the vertical portion, and is connected to a power supply; and a coil binding portion that is stood obliquely from one end of the horizontal portion, and around which a coil is wound.

According to the present invention, it is possible to extinguish the arc effectively regardless of the direction of the current flowing between the movable contact and the fixed contact, and reduce the manufacturing cost.

### BRIEF DESCRIPTION OF THE DRAWINGS

FIG. 1 is an exploded view of an electromagnetic relay (relay) 1 according to a present embodiment;

FIG. 2 is a perspective view of the relay 1;

FIG. 3A is a diagram illustrating internal structure of a case 10;

FIG. 3B is a side view of an armature 16;

FIG. 4A is a front view of a movable contact spring 18;

FIG. 4B is a side view of the movable contact spring 18;

FIG. 4C is a front view of fixed contact terminals 22a and 22b;

FIG. 4D is a side view of the fixed contact terminals 22a and 22b;

FIGS. 5A and 5B are diagrams illustrating variations of the relay 1;

FIG. 6A is a diagram schematically illustrating a direction of a current flowing into the relay 1;

FIG. 6B is a diagram illustrating an arc-extinguishing state as viewed from a side of the fixed contact terminal 22a;

FIG. 6C is a diagram illustrating an arc-extinguishing state as viewed from a side of the fixed contact terminal 22b;

FIG. 7A is a diagram schematically illustrating a direction of a current flowing into the relay 1;

FIG. 7B is a diagram illustrating an arc-extinguishing state as viewed from the side of the fixed contact terminal 22a;

FIG. 7C is a diagram illustrating an arc-extinguishing state as viewed from the side of the fixed contact terminal 22b;

FIG. 8A is a front view of a movable contact spring 180;

FIG. 8B is a side view of the movable contact spring 180;

FIG. 8C is a front view of a variation of the movable contact spring 180;

FIG. 8D is a side view of the variation of the movable contact spring 180;

FIG. 9A is a front view of fixed contact terminals 220a and 220b;

FIG. 9B is a side view of the fixed contact terminals 220a and 220b;

FIG. 10A is a diagram illustrating an arc-extinguishing state as viewed from a side of the fixed contact terminal 220a;

FIG. 10B is a diagram illustrating an arc-extinguishing state as viewed from a side of the fixed contact terminal 220b;

FIG. 11 is a cross-portion view of the relay 1;

FIG. 12A is a perspective view of the electromagnetic relay 1 when the case 10 is removed;

FIG. 12B is a cross-portion view taken along line A-A of FIG. 12A;

FIG. 13A is a diagram schematically illustrating the configuration of a base 28 and a pair of coil terminals 32;

FIG. 13B is a diagram illustrating a state where the pair of coil terminals 32 is pressed into the base 28;

FIG. 13C is a rear view of the base 28;

FIG. 13D is a diagram illustrating a coil terminal 32b;

FIG. 14 is a diagram illustrating a coil terminal mounted on a conventional relay;

FIG. 15A is a bottom view of the relay 1 when the case 10 is not mounted; and

FIG. 15B is a bottom view of the relay 1 when the case 10 is mounted.

### DETAILED DESCRIPTION

Hereinafter, a description will be given of embodiments with drawings.

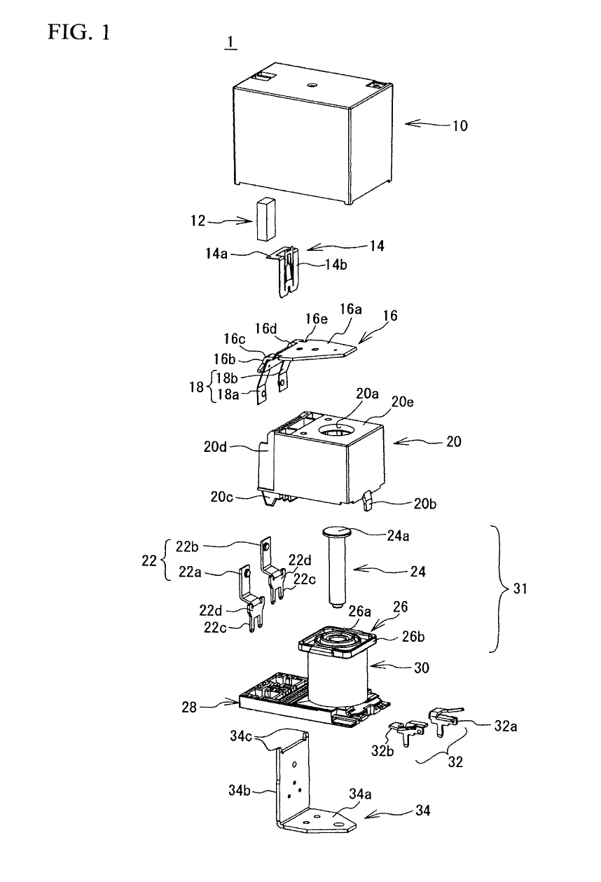

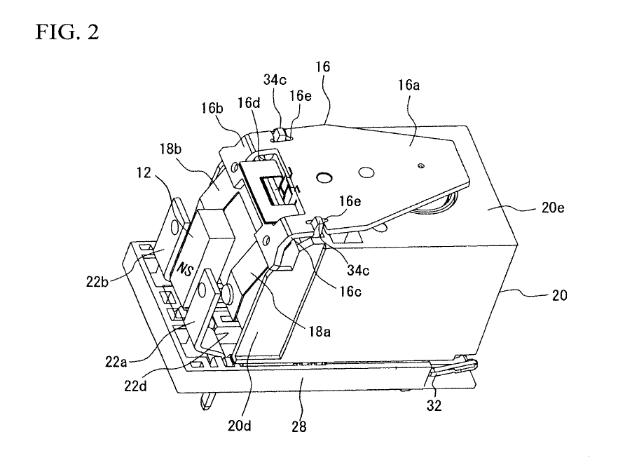

FIG. 1 is an exploded view of an electromagnetic relay (hereinafter referred to as “relay”) 1 according to a present embodiment. FIG. 2 is a perspective view of the relay 1.

The relay 1 according to the present embodiment is a direct current (DC) high voltage type relay, and is used as a relay for battery pre-charge (prevention of an inrush current to a main relay contact) of an electric vehicle, for example. Here, the DC high voltage does not mean a high voltage prescribed in IEC (International Electrotechnical Commission) but means a voltage more than 12 VDC or 24 VDC used in a general car battery, for example.

The relay 1 has to reliably extinguish an arc generated between a fixed contact and a movable contact at the time of load block of the DC high voltage. In the general DC high voltage type relay, a polarity is designated to connection of a load side. However, in the relay 1 which is the relay for battery pre-charge, current directions reverse each other at the time of battery charging and discharging, and it is therefore required that the polarity of connection of the load side is not designated. Therefore, the relay 1 has to extinguish the arc regardless of a direction of the current flowing between the movable contact and the fixed contact. Here, the use of the relay 1 is not limited to the electric vehicle, and the relay 1 can be used for various devices and facilities.

As illustrated in FIG. 1, the relay 1 includes a case 10, a permanent magnet 12 for extinguishing magnetic arc, a hinge spring 14, an armature 16, a movable contact spring 18, an insulating cover 20, fixed contact terminals 22 (22a and 22b), an iron core 24, a spool 26, a base 28, a coil 30, a pair of coil terminals 32 (32a and 32b), and a yoke 34. The pair of coil terminals 32 (32a and 32b) supplies a current to excite an electromagnetic device composed of the iron core 24, the spool 26 and the coil 30.

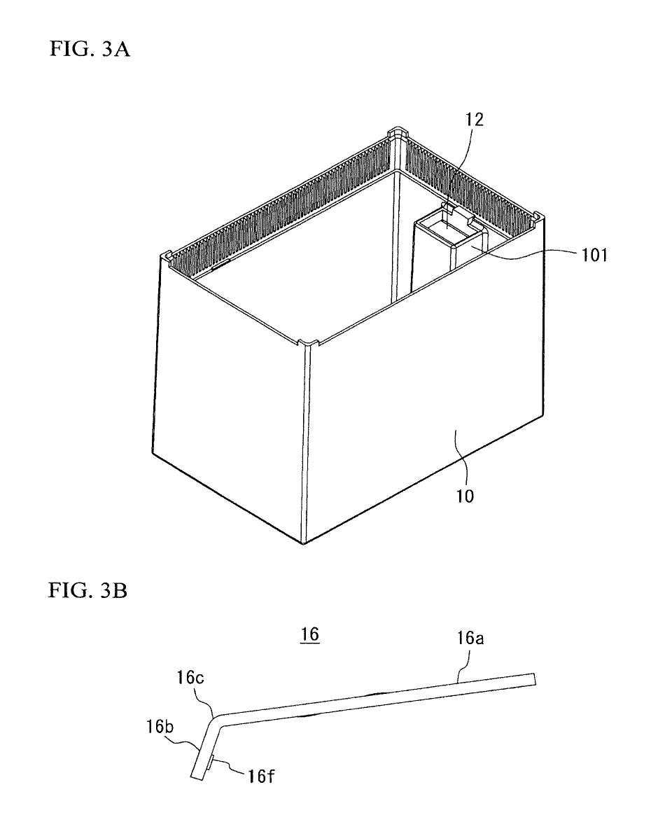

As illustrated in FIG. 3A, a magnet holder 101 is formed in the inside of the case 10, and the permanent magnet 12 is held in the magnet holder 101. The permanent magnet 12 held in the magnet holder 101 is arranged between the fixed contact terminals 22a and 22b, as illustrated in FIG. 2. In FIG. 2, the case 10 is omitted. For example, a surface having a N-pole of the permanent magnet 12 is directed to a side of the fixed contact terminal 22b, and a surface having a S-pole of the permanent magnet 12 is directed to a side of the fixed contact terminal 22a. The positions of the surface having the N-pole and the surface having the S-pole may be reversed each other. Moreover, a samarium cobalt magnet which is superior in residual flux density, coercive force and heat resistance is used as the permanent magnet 12, for example. Especially, since the heat of the arc reaches the permanent magnet 12, the samarium cobalt magnet which is superior in the heat resistance to a neodymium magnet is used.

Referring to FIG. 1, the hinge spring 14 is formed in an inverted L-shape in a side view, and includes a horizontal portion 14a that biases a suspended portion 16b of the armature 16 downward, and a suspended portion 14b that is fixed to a vertical portion 34b of the yoke 34.

The armature 16 is a magnetic body having a dogleg-shaped in a side view, and includes a flat plate portion 16a that is attracted by the iron core 24, and the suspended portion 16b extending downward from the flat plate portion 16a via a bent portion 16c, as illustrated in FIG. 3B. Moreover, a through-hole 16d is formed in the center of the bent portion 16c so that the horizontal portion 14a of the hinge spring 14 protrudes, as illustrated in FIGS. 1 and 2. Cutout portions 16e into which projecting portions 34c of the yoke 34 are fitted are formed on the flat plate portion 16a. Projections 16f for fixing the movable contact spring 18 to the suspended portion 16b by caulking are provided on the suspended portion 16b.

The armature 16 performs rotary motion with the cutout portions 16e, as a fulcrum, into which the projecting portions 34c of the yoke 34 are fitted. When a current flows into the coil 30, the iron core 24 attracts the flat plate portion 16a. At this time, the horizontal portion 14a of the hinge spring 14 contacts the suspended portion 16b and is pushed upward from the suspended portion 16b. When the current of the coil 30 is cut off, the suspended portion 16b is pushed down by a restoring force of the horizontal portion 14a of the hinge spring 14. Thereby, the flat plate portion 16a is separated from the iron core 24. Here, a surface of the flat plate portion 16a opposite to the iron core 24 or the insulating cover 20 is defined as a first surface, and a rear surface of the first surface is defined as a second surface. Moreover, a surface of the suspended portion 16b opposite to the yoke 34 or the insulating cover 20 is defined as a first surface, and a rear surface of the first surface is defined as a second surface.

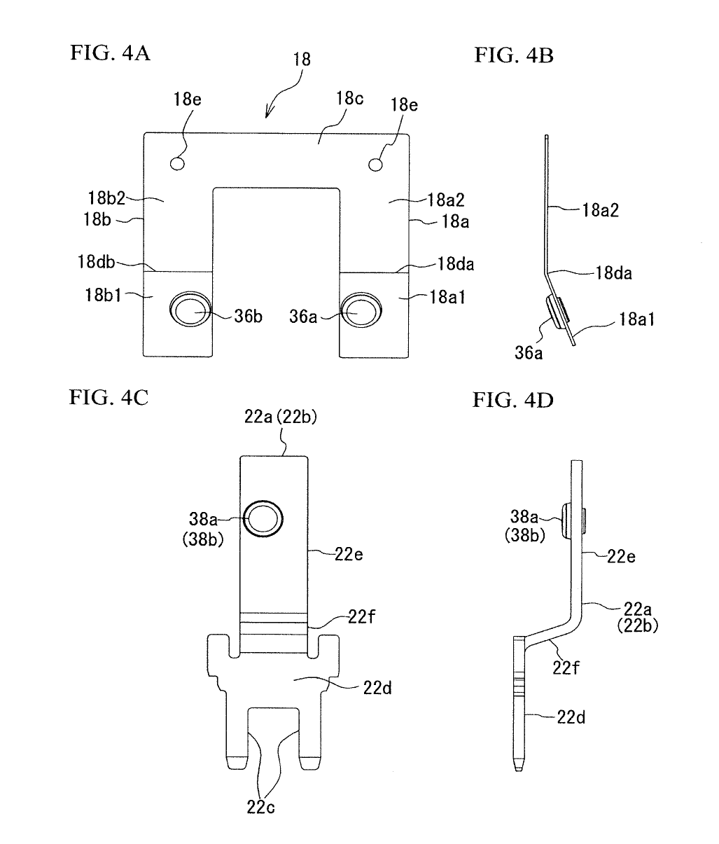

FIG. 4A is a front view of the movable contact spring 18, and FIG. 4B is a side view of the movable contact spring 18. FIG. 4C is a front view of fixed contact terminals 22a and 22b, and FIG. 4D is a side view of the fixed contact terminals 22a and 22b.

The movable contact spring 18 is a conductive plate spring having a U shape in a front view, and includes a pair of movable pieces, i.e., a first movable piece 18a and a second movable piece 18b, and a coupling portion 18c that couples upper ends of the first movable piece 18a and the second movable piece 18b with each other.

The first movable piece 18a and the second movable piece 18b are bent at positions 18da and 18db which are nearer to the bottom ends than the centers, respectively. Here, a portion below the position 18da of the first movable piece 18a is defined as a lower portion 18a1, and a portion above the position 18da of the first movable piece 18a is defined as an upper portion 18a2. Similarly, a portion below the position 18db of the second movable piece 18b is defined as a lower portion 18b1, and a portion above the position 18db of the second movable piece 18b is defined as an upper portion 18b2.

A movable contact 36a composed of a material having excellent arc resistance is provided on the lower portion 18a1 of the first movable piece 18a. A movable contact 36b composed of a material having excellent arc resistance is provided on the lower portion 18b1 of the second movable piece 18b. In the first movable piece 18a and the second movable piece 18b, the upper portion 18a2 of the first movable piece 18a and the upper portion 18b2 of the second movable piece 18b are bent in a direction away from fixed contacts 38a and 38b (i.e., a fixed contact and a second fixed contact) mentioned later which the movable contacts 36a and 36b (i.e., a first movable contact and a second movable contact) contact, respectively.

Through-holes 18e into which the projections 16f provided on the suspended portion 16b are fitted are formed on the coupling portion 18c. The projections 16f are fitted and caulked into the through-holes 18e, so that the movable contact spring 18 is fixed to the first surface of the suspended portion 16b of the armature 16.

The fixed contact terminals 22a and 22b are press-fitted to through-holes, not shown, provided on the base 28 from above, and are fixed to the base 28. The fixed contact terminals 22a and 22b are bent like a crank in a side view. Each of the fixed contact terminals 22a and 22b includes an upper portion 22e, an inclined portion 22f and a lower portion 22d. The upper portion 22e is coupled with the lower portion 22d via the inclined portion 22f, and the upper portion 22e, the inclined portion 22f and the lower portion 22d are integrally formed. The lower portion 22d that fixes the fixed contact terminals 22a and 22b to the base 28 functions as a fulcrum. The upper portion 22e is bent so as to separate from the movable contact spring 18 or the insulating cover 20 than the lower portion 22d. The fixed contacts 38a and 38b composed of a material having excellent arc resistance are provided on the upper portions 22e of the fixed contact terminals 22a and 22b, respectively. A bifurcated terminal 22c to be connected to a power supply, not shown, is provided on the lower portions 22d of the fixed contact terminals 22a and 22b.

Referring to FIG. 1, the insulating cover 20 is made of resin, and a through-hole 20a exposing a head portion 24a of the iron core 24 is formed on a ceiling portion 20e of the insulating cover 20. Projection-shaped fixing portions 20b (i.e., a first fixing portion) and 20c (i.e., a second fixing portion) are formed on a bottom portion of the insulating cover 20 to fix the insulating cover 20 to the base 28. The fixing portion 20b engages with one end of the base 28, and the fixing portion 20c is inserted into a hole, not shown, of the base 28. Moreover, a back stop 20d made of resin is integrally formed with the insulating cover 20. When the current does not flow into the coil 30 (i.e., when an electromagnetic device 31 mentioned later is OFF), the back stop 20d as a stopper contacts the movable contact spring 18. By the back stop 20d, the occurrence of a collision sound of metal parts such as the movable contact spring 18 and the yoke 34 can be suppressed. Therefore, an operating sound of the relay 1 can be reduced.

The iron core 24 is inserted into a through-hole 26a formed on a head portion 26b of the spool 26. The coil 30 is wound around the spool 26, and integrally formed with the base 28. The iron core 24, the spool 26 and the coil 30 constitute the electromagnetic device 31. The electromagnetic device 31 attracts the flat plate portion 16a of the armature 16 or release the attraction thereof in accordance with ON/OFF of the current. Thereby, opening or closing action of the movable contact spring 18 against the fixed contact terminals 22a and 22b is carried out. The pair of coil terminals 32 is press-fitted into the base 28, and the wiring of the coil 30 is entwined with each of the pair of coil terminals 32.

The yoke 34 is an L-shaped conductive member in a side view, and includes a horizontal portion 34a that is fixed to a rear surface of the base 28, and the vertical portion 34b that is erected vertically to the horizontal portion 34a. The vertical portion 34b is press-fitted into a through-hole, not shown, of the base 28 and a through-hole, not shown, of the insulating cover 20 from the bottom of the base 28. Thereby, the projecting portions 34c provided on both ends of the top of the vertical portion 34b protrude from the ceiling portion 20e of the insulating cover 20, as illustrated in FIG. 2.

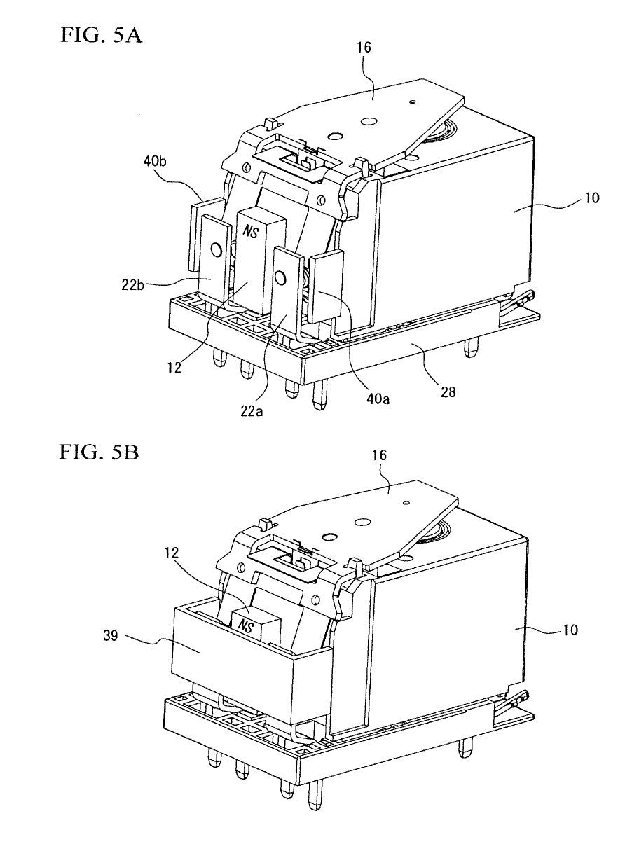

Here, to stabilize a direction of the magnetic flux of the permanent magnet 12 and to reduce leak magnetic flux, two plate-like yokes 40a and 40b may be provided, as illustrated in FIG. 5A. In this case, the yoke 40a is arranged opposite to the surface having the pole (e.g. the S-pole) of the permanent magnet 12, and is arranged so that the permanent magnet 12 and the yoke 40a sandwich the fixed contact terminal 22a. The yoke 40b is arranged to opposite to the surface having the pole (e.g. the N-pole) of the permanent magnet 12, and is arranged so that the permanent magnet 12 and the yoke 40b sandwich the fixed contact terminal 22b. Alternatively, to stabilize the direction of the magnetic flux of the permanent magnet 12 and to reduce the leak magnetic flux, a U-shaped yoke 39 may be provided, as illustrated in FIG. 5B. In this case, the yoke 39 is arranged opposite to two surfaces having respective poles of the permanent magnet 12, and is arranged so as to surround the permanent magnet 12 and the fixed contact terminals 22a and 22b.

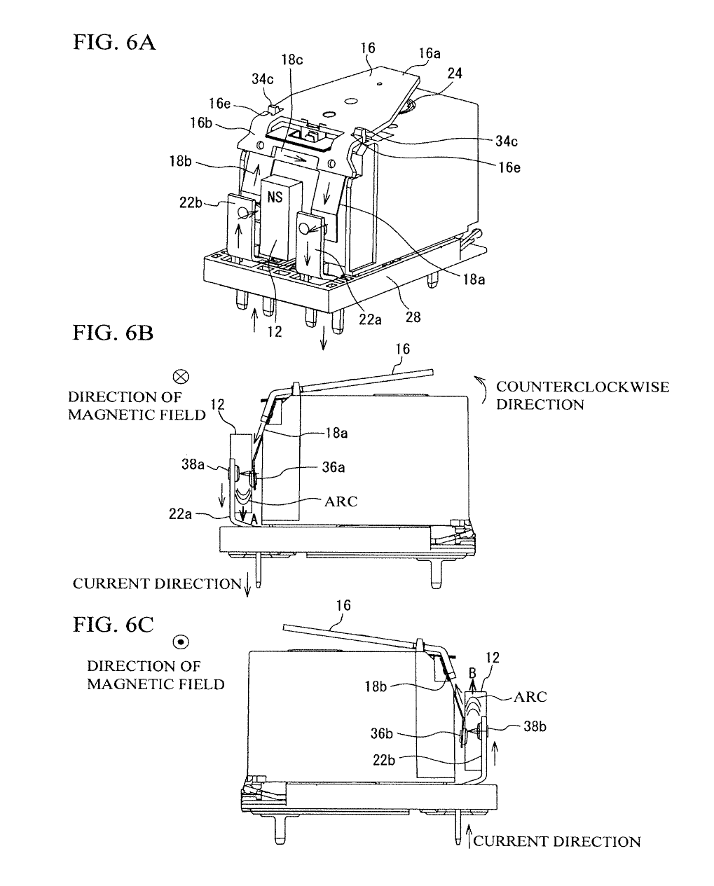

FIG. 6A is a diagram schematically illustrating a direction of a current flowing into the relay 1, and especially illustrates a state where the fixed contacts and the movable contacts are separated. FIG. 6B is a diagram illustrating an arc-extinguishing state as viewed from a side of the fixed contact terminal 22a, and FIG. 6C is a diagram illustrating an arc-extinguishing state as viewed from a side of the fixed contact terminal 22b. In FIGS. 6A to 6C, a direction (a first direction) in which the current flows is indicated by arrows.

In FIG. 6A, any one of the fixed contact terminals 22a and 22b is connected to a power supply side, not shown, and the other is connected to a load side, not shown. When the current flows into the coil 30, the iron core 24 attracts the flat plate portion 16a, and the armature 16 rotates with the projecting portions 34c and the cutout portions 16e as fulcrums. The suspended portion 16b and the movable contact spring 18 fixed to the suspended portion 16b rotate with the rotation of the armature 16, and the movable contacts 36a and 36b contact corresponding fixed contacts 38a and 38b, respectively. When a voltage is applied to the fixed contact terminal 22b in a state where the movable contacts 36a and 36b contact the fixed contacts 38a and 38b, for example, the current flows into the fixed contact terminal 22b, the fixed contact 38b, the movable contact 36b, the second movable piece 18b, the coupling portion 18c, the first movable piece 18a, the movable contact 36a, the fixed contact 38a and the fixed contact terminal 22a in this order, as illustrated in FIG. 6A. Then, when the current which flows into the coil 30 is cut off, the armature 16 rotates counterclockwise illustrated in FIG. 6B by the restoring force of the hinge spring 14. Although the movable contacts 36a and 36b begin to separate from the fixed contacts 38a and 38b by the rotation of the armature 16, respectively, the current flowing between the movable contact 36a and the fixed contact 38a and the current flowing between the movable contact 36b and the fixed contact 38b are not completely interrupted, and the arc occurs between the fixed contacts 38a and 38b and the movable contacts 36a and 36b.

In the relay 1 illustrated in FIGS. 6A to 6C, a direction of the magnetic field is a depth direction toward the fixed contact terminal 22b from the fixed contact terminal 22a as illustrated in FIG. 6B in a place where the current flows from the movable contact 36a to the fixed contact 38a. Therefore, the arc which occurs between the movable contact 36a and the fixed contact 38a is extended in a space in a lower direction (a third direction) by Lorentz force as indicated by an arrow A of FIG. 6B and extinguished. On the other hand, in a place where the current flows from the fixed contact 38b to the movable contact 36b, the direction of the magnetic field is the depth direction toward the fixed contact terminal 22b from the fixed contact terminal 22a as illustrated in FIG. 6C. Therefore, the arc which occurs between the movable contact 36b and the fixed contact 38b is extended in a space in an upper direction (a fourth direction) by Lorentz force as indicated by an arrow B of FIG. 6C and extinguished.

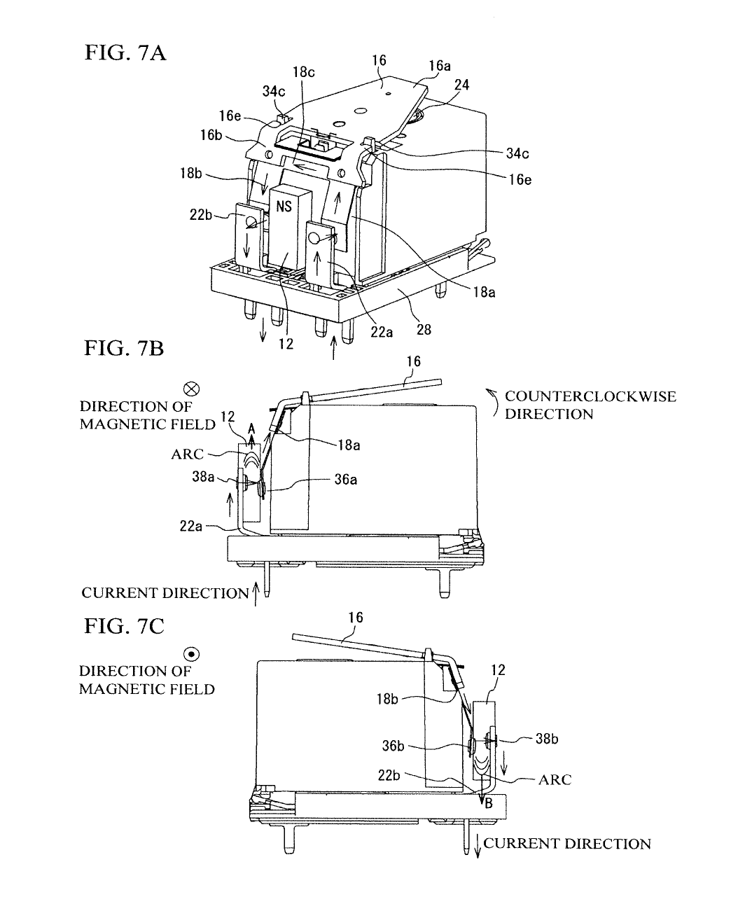

FIG. 7A is a diagram schematically illustrating a direction of the current flowing into the relay 1. FIG. 7B is a diagram illustrating an arc-extinguishing state as viewed from the side of the fixed contact terminal 22a, and FIG. 7C is a diagram illustrating an arc-extinguishing state as viewed from the side of the fixed contact terminal 22b. In FIGS. 7A to 7C, a direction (a second direction) in which the current flows is indicated by arrows. Here, the direction in which the current flows is reversed to the example of FIGS. 6A to 6C.

In FIG. 7A, as with FIG. 6A, any one of the fixed contact terminals 22a and 22b is connected to the power supply side, not shown, and the other is connected to the load side, not shown. When the current flows into the coil 30, the iron core 24 attracts the flat plate portion 16a, and the armature 16 rotates with the projecting portions 34c and the cutout portions 16e as fulcrums. The suspended portion 16b and the movable contact spring 18 fixed to the suspended portion 16b rotate with the rotation of the armature 16, and the movable contacts 36a and 36b contact corresponding fixed contacts 38a and 38b, respectively. When a voltage is applied to the fixed contact terminal 22a in a state where the movable contacts 36a and 36b contact the fixed contacts 38a and 38b, for example, the current flows into the fixed contact terminal 22a, the fixed contact 38a, the movable contact 36a, the first movable piece 18a, the coupling portion 18c, the second movable piece 18b, the movable contact 36b, the fixed contact 38b and the fixed contact terminal 22b in this order, as illustrated in FIG. 7A. Then, when the current which flows into the coil 30 is cut off, the armature 16 rotates counterclockwise illustrated in FIG. 7B by the restoring force of the hinge spring 14. Although the movable contacts 36a and 36b begin to separate from the fixed contacts 38a and 38b by the rotation of the armature 16, respectively, the current flowing between the movable contact 36a and the fixed contact 38a and the current flowing between the movable contact 36b and the fixed contact 38b are not completely interrupted, and the arc occurs between the fixed contacts 38a and 38b and the movable contacts 36a and 36b.

In the relay 1 illustrated in FIGS. 7A to 7C, the direction of the magnetic field is the depth direction toward the fixed contact terminal 22b from the fixed contact terminal 22a as illustrated in FIG. 7B in a place where the current flows from the fixed contact 38a to movable contact 36a. Therefore, the arc which occurs between the movable contact 36a and the fixed contact 38a is extended in a space in the upper direction by Lorentz force as indicated by an arrow A of FIG. 7B and extinguished. On the other hand, in a place where the current flows from the movable contact 36b to the fixed contact 38b, the direction of the magnetic field is the depth direction toward the fixed contact terminal 22b from the fixed contact terminal 22a as illustrated in FIG. 7C. Therefore, the arc which occurs between the movable contact 36b and the fixed contact 38b is extended in a space in the lower direction by Lorentz force as indicated by an arrow B of FIG. 7C and extinguished.

Therefore, according to FIGS. 6A to 7C, the relay 1 of the present embodiment can extend the arc which occurs between the movable contact 36a and the fixed contact 38a and the arc which occurs between the movable contact 36b and the fixed contact 38b in the spaces of the opposite direction at the same time, respectively, and extinguish them, regardless of the directions of the current flowing between the movable contact 36a and the fixed contact 38a and the current flowing between the movable contact 36b and the fixed contact 38b.

The fulcrums (e.g. the cutout portions 16e) of a movable member including the armature 16 and the movable contact spring 18 are arranged above the movable contacts 36a and 36b or the fixed contacts 38a and 38b, and the fulcrums (e.g. the lower portions 22d) of the fixed contact terminals 22a and 22b are arranged below the movable contacts 36a and 36b or the fixed contacts 38a and 38b. Therefore, even when the arc which occurs between the movable contact 36a and the fixed contact 38a is extended upward or downward according to the direction of the current flowing between the movable contact 36a and the fixed contact 38a, it is possible to secure the spaces for extending the arc. Similarly, even when the arc which occurs between the movable contact 36b and the fixed contact 38b is extended upward or downward according to the direction of the current flowing between the movable contact 36b and the fixed contact 38b, it is possible to secure the spaces for extending the arc.

In the following, a description will be given of a variation of the movable contact spring 18 and a variation of the fixed contact terminals 22a and 22b.

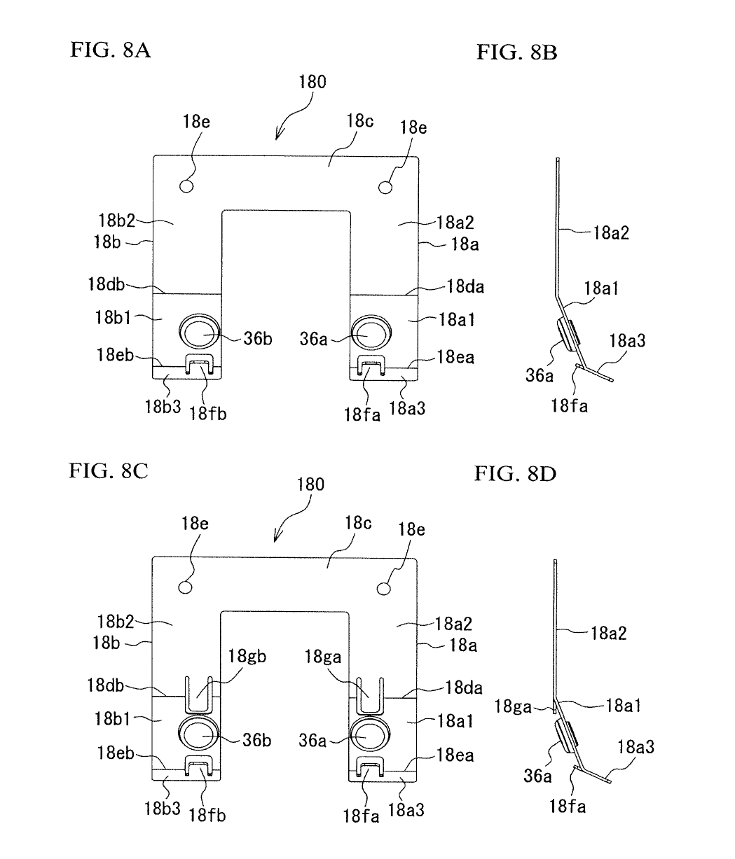

FIG. 8A is a front view of a movable contact spring 180, and FIG. 8B is a side view of the movable contact spring 180. FIG. 8C is a front view of a variation of the movable contact spring 180, and FIG. 8D is a side view of the variation of the movable contact spring 180. Components of the movable contact spring 180 identical with those of the movable contact spring 18 of FIGS. 4A and 4B are designated by identical reference numerals.

The movable contact spring 180 is a conductive plate spring having a U shape in a front view, and includes the pair of movable pieces, i.e., the first movable piece 18a and the second movable piece 18b, and the coupling portion 18c that couples upper ends of the first movable piece 18a and the second movable piece 18b with each other.

The first movable piece 18a is bent twice at the position 18da nearer to the bottom end than the center and a position 18ea nearer to the bottom end than the position 18da. The second movable piece 18b is bent twice at the position 18db nearer to the bottom end than the center and a position 18eb nearer to the bottom end than the position 18db. Here, a portion below the position 18ea of the first movable piece 18a is defined as a lowest portion 18a3, a portion between the positions 18ea and 18da is defined as the lower portion 18a1, and a portion above the position 18da of the first movable piece 18a is defined as the upper portion 18a2. Similarly, a portion below the position 18eb of the second movable piece 18b is defined as a lowest portion 18b3, a portion between the positions 18eb and 18db is defined as the lower portion 18b1, and a portion above the position 18db of the second movable piece 18b is defined as the upper portion 18b2.

The movable contact 36a composed of the material having excellent arc resistance is provided on the lower portion 18a1 of the first movable piece 18a. The movable contact 36b composed of the material having excellent arc resistance is provided on the lower portion 18b1 of the second movable piece 18b. In the first movable piece 18a and the second movable piece 18b, the upper portion 18a2 and the lowest portion 18a3 of the first movable piece 18a and the upper portion 18b2 and the lowest portion 18b3 of the second movable piece 18b are bent in a direction away from the fixed contact terminals 22a and 22b, respectively.

The upper portions 18a2 and 18b2 function as an arc runner which moves the arc generated between the contacts to the space in the upper direction. The lowest portions 18a3 and 18b3 function as an arc runner which moves the arc generated between the contacts to the space in the lower direction.

Through-holes 18e into which the projections 16f provided on the suspended portion 16b are fitted are formed on the coupling portion 18c. The projections 16f are fitted and caulked into the through-holes 18e, so that the movable contact spring 18 is fixed to the first surface of the suspended portion 16b of the armature 16.

Formed on the first movable piece 18a is a cut-and-raised portion 18fa (a first cut-and-raised portion) that projects toward the movable contact 36a from the lowest portion 18a3 along a surface of the lowest portion 18a3 and inclines with respect to the lower portion 18a1. Moreover, formed on the second movable piece 18b is a cut-and-raised portion 18fb (the first cut-and-raised portion) that projects toward the movable contact 36b from the lowest portion 18b3 along a surface of the lowest portion 18b3 and inclines with respect to the lower portion 18b1. By the cut-and-raised portions 18fa and 18fb coupled with the lowest portions 18a3 and 18b3, a distance between the movable contact 36a and the lowest portion 18a3 (i.e., a member other than the contact) and a distance between the movable contact 36b and the lowest portion 18b3 are reduced. Therefore, the arc generated between the movable contact 36a and the fixed contact 38a and the arc generated between the movable contact 36b and the fixed contact 38b can quickly move from these contacts to the lowest portions 18a3 and 18b3 (i.e., the member other than the contact), respectively. Therefore, the cut-and-raised portions 18fa and 18fb can suppress the wear of the contacts.

Moreover, formed on the first movable piece 18a may be a cut-and-raised portion 18ga (a second cut-and-raised portion) that projects toward the movable contact 36a from the upper portion 18a2 so as to incline with respect to the lower portion 18a1 along a surface of the upper portion 18a2, as illustrated in FIGS. 8C and 8D. In addition, formed on the second movable piece 18b may be a cut-and-raised portion 18gb (the second cut-and-raised portion) that projects toward the movable contact 36b from the upper portion 18b2 so as to incline with respect to the lower portion 18b1 along a surface of the upper portion 18b2.

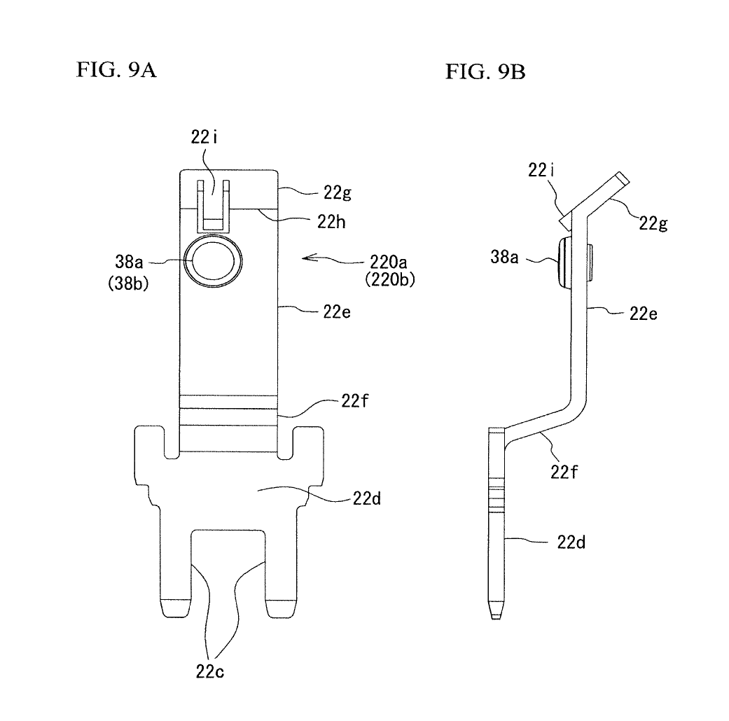

FIG. 9A is a front view of fixed contact terminals 220a and 220b, and FIG. 9B is a side view of the fixed contact terminals 220a and 220b. Components of the fixed contact terminals 220a and 220b identical with those of the fixed contact terminals 22a and 22b of FIGS. 4C and 4D are designated by identical reference numerals.

The fixed contact terminals 220a and 220b are press-fitted to through-holes, not shown, provided on the base 28 from above, and are fixed to the base 28. The fixed contact terminals 220a and 220b are bent like a crank in a side view. Each of the fixed contact terminals 220a and 220b includes an uppermost portion 22g, the upper portion 22e, the inclined portion 22f and the lower portion 22d. The lower portion 22d that fixes the fixed contact terminals 220a and 220b to the base 28 functions as the fulcrum. The upper portion 22e is bent so as to separate from the movable contact spring 180 or the insulating cover 20 than the lower portion 22d. The fixed contacts 38a and 38b composed of a material having excellent arc resistance are provided on the upper portions 22e of the fixed contact terminals 220a and 220b, respectively. The bifurcated terminal 22c to be connected to the power supply, not shown, is provided on the lower portions 22d of the fixed contact terminals 220a and 220b.

The fixed contact terminals 220a and 220b are different in the inclusion of the uppermost portion 22g from the fixed contact terminals 22a and 22b of FIG. 4C. The uppermost portion 22g is formed by bending the fixed contact terminals 220a and 220b at a position 22h higher than the fixed contacts 38a and 38b. In FIGS. 9A and 9B, a portion above the position 22h is the uppermost portion 22g, and a portion between the position 22h and the inclined portion 22f is the upper portion 22e.

The uppermost portion 22g is bent so as to separate from the movable contact spring 180 or the insulating cover 20 than the upper portion 22e. The uppermost portions 22g functions as an arc runner which moves the arc generated between the contacts to the space in the upper direction. Moreover, formed on the fixed contact terminals 220a and 220b is a cut-and-raised portion 22i (a third cut-and-raised portion) that projects toward the fixed contacts 38a and 38b from the uppermost portion 22g so as to incline with respect to the upper portion 22e along a surface of the uppermost portion 22g.

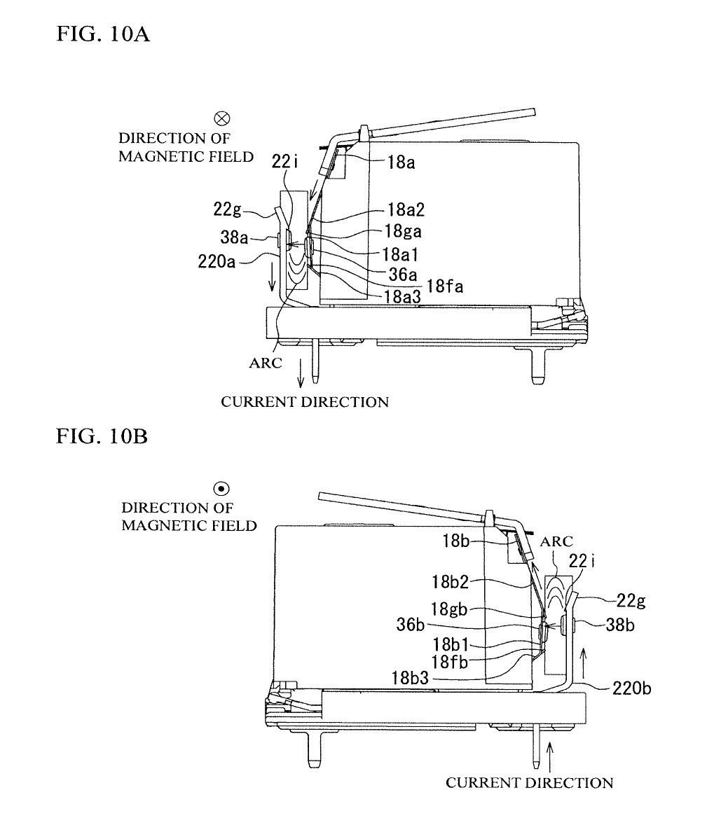

FIG. 10A is a diagram illustrating an arc-extinguishing state as viewed from the side of the fixed contact terminal 220a, and FIG. 10B is a diagram illustrating an arc-extinguishing state as viewed from the side of the fixed contact terminal 220b. In FIGS. 10A and 10B, a direction in which the current flows is indicates by arrows.

As illustrated in FIGS. 10A and 10B, the first movable piece 18a and the second movable piece 18b are bent in a direction in which the upper portion 18a2 and the lowest portion 18a3 of the first movable piece 18a and the upper portion 18b2 and the lowest portion 18b3 of the second movable piece 18b separate from the fixed contact terminals 220a and 220b opposite to the movable contacts 36a and 36b, respectively. Moreover, the uppermost portion 22g of the fixed contact terminals 220a and 220b is bent in the direction away from the movable contact spring 180 or the insulating cover 20.

Thereby, the uppermost portion 22g, the upper portion 18a2 and the upper portion 18b2 can quickly move the arc generated between the movable contact 36a and the fixed contact 38a and the arc generated between the movable contact 36b and the fixed contact 38b to the space in the upper direction, and can reduce the wear of the movable contacts 36a and 36b and the fixed contacts 38a and 38b. Especially, a gap between the uppermost portion 22g and the upper portions 18a2 and 18b2 gradually spreads in a horizontal direction of FIGS. 10A and 10B as going to the upper direction of FIGS. 10A and 10B. Moreover, a gap between the fixed contact terminal 220a and the lowest portion 18b3 gradually spreads in a horizontal direction of FIGS. 10A and 10B as going to the lower direction of FIGS. 10A and 10B. By gradually spreading the gaps, the arc moving upward or downward can be extended in a horizontal direction of FIGS. 10A and 10B, and be extinguished more effectively.

Similarly, the lowest portion 18a3 and 18b3 can quickly move the arc generated between the movable contact 36a and the fixed contact 38a and the arc generated between the movable contact 36b and the fixed contact 38b to the space in the lower direction, and can reduce the wear of the movable contacts 36a and 36b and the fixed contacts 38a and 38b.

Then, the cut-and-raised portion 22i is formed toward the fixed contacts 38a and 38b from the uppermost portion 22g functioning as the arc runner, so that the arc can be quickly moved to the arc runner, and the wear of the fixed contacts 38a and 38b can be reduced. Here, a reason why the formation of the cut-and-raised portions can quickly move the arc to the arc runner is that a distance in which the arc moves from the fixed contacts or the movable contacts to a member other than their contacts (here, the cut-and-raised portions coupled with the arc runner) is reduced compared with a case where the cut-and-raised portions are not formed. The cut-and-raised portions 18ga and 18fa are formed toward the movable contact 36a from the upper portion 18a2 functioning as the arc runner and the lowest portion 18a3, so that the arc can be quickly moved to the arc runner, and the wear of the movable contact 36a can be reduced. The cut-and-raised portions 18gb and 18fb are formed toward the movable contact 36b from the upper portion 18b2 functioning as the arc runner and the lowest portion 18b3, so that the arc can be quickly moved to the arc runner, and the wear of the movable contact 36b can be reduced.

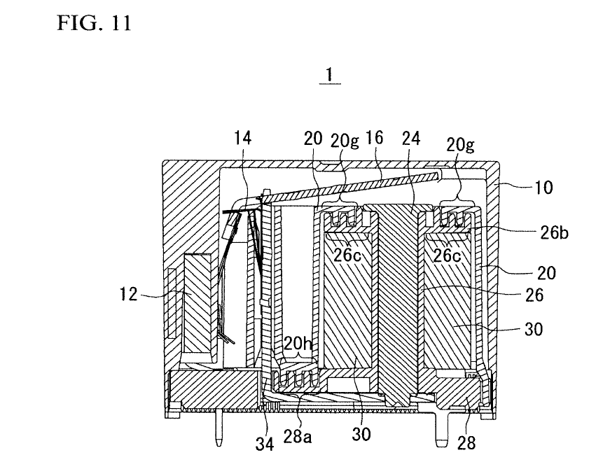

FIG. 11 is a cross-portion view of the relay 1. The relay 1 is a direct current high voltage type relay. It is necessary to secure an insulating distance (i.e., a space and a creepage distance) between a strong electrical side (specifically, the armature 16, the movable contact spring 18, the fixed contact terminals 22a and 22b, the iron core 24 and the yoke 34) into which the current as a power to be supplied to a load flows, and a weak electrical side (specifically, the coil 30) into which a current for exciting the electromagnet flows. However, when the insulating distance is provided linearly inside the relay 1, the relay 1 increases in size.

For this reason, the spool 26 which is arranged between the head portion 24a of the iron core 24 and the coil 30 includes an uneven portion 26c (a third uneven portion) on the head portion 24a, as illustrated in FIG. 11. Moreover, the base 28 which is arranged between the coil 30 and the yoke 34 includes an uneven portion 28a (a fourth uneven portion) in its own part. In addition, an inner wall of the insulating cover 20 includes an uneven portion 20g (a first uneven portion) and an uneven portion 20h (a second uneven portion) at positions opposite to the uneven portion 26c and the uneven portion 28a, respectively.

The uneven portion 20g of the insulating cover 20 is fitted into the uneven portion 26c of the spool 26. These uneven portions are provided, so that the sufficient insulating distance can be secured between the head portion 24a of the iron core 24 and the coil 30 without increasing the relay 1 in size. Moreover, the uneven portion 20h of the insulating cover 20 is fitted into the uneven portion 28a of the base 28. Thereby, the sufficient insulating distance can be secured between the coil 30 and the yoke 34 without increasing the relay 1 in size.

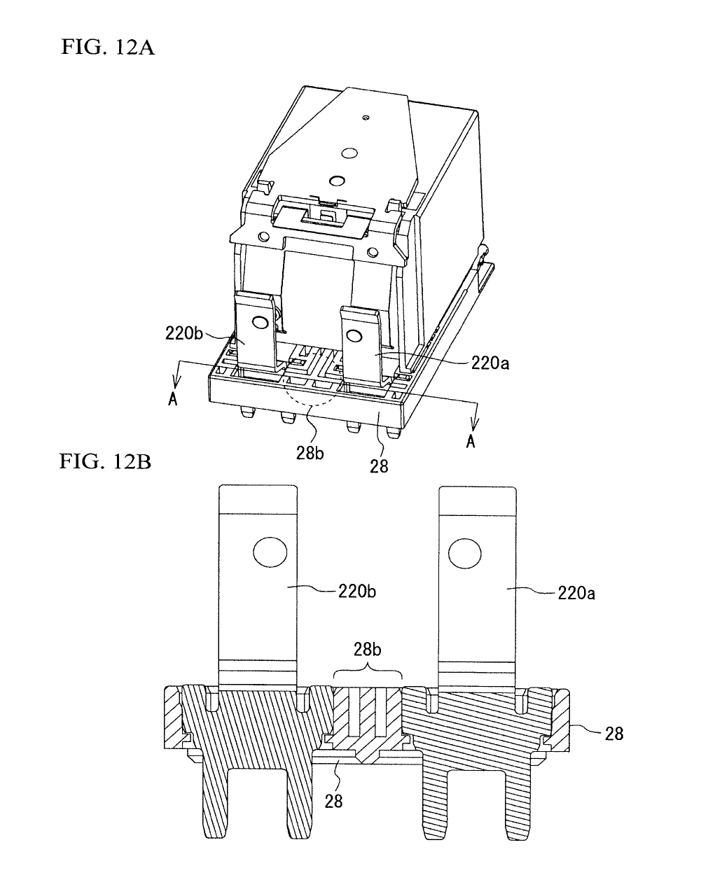

FIG. 12A is a perspective view of the electromagnetic relay 1 when the case 10 is removed. FIG. 12B is a cross-portion view taken along line A-A of FIG. 12A.

By dusts generated due to consumption of the movable contacts 36a and 36b and the fixed contacts 38a and 38b, an insulating performance between the fixed contact terminals 220a and 220b deteriorates, and tracking may occur. For this reason, the base 28 includes an uneven portion 28b (a fifth uneven portion) between the fixed contact terminals 220a and 220b, as illustrated in FIGS. 12A and 12B. Thereby, irregularities are formed between the fixed contact terminals 220a and 220b, so that the creepage distance between the fixed contact terminals 220a and 220b can be secured, and anti-tracking performance can be improved. Here, in FIGS. 12A and 12B, the fixed contact terminals 220a and 220b are used, but the fixed contact terminals 22a and 22b may be used.

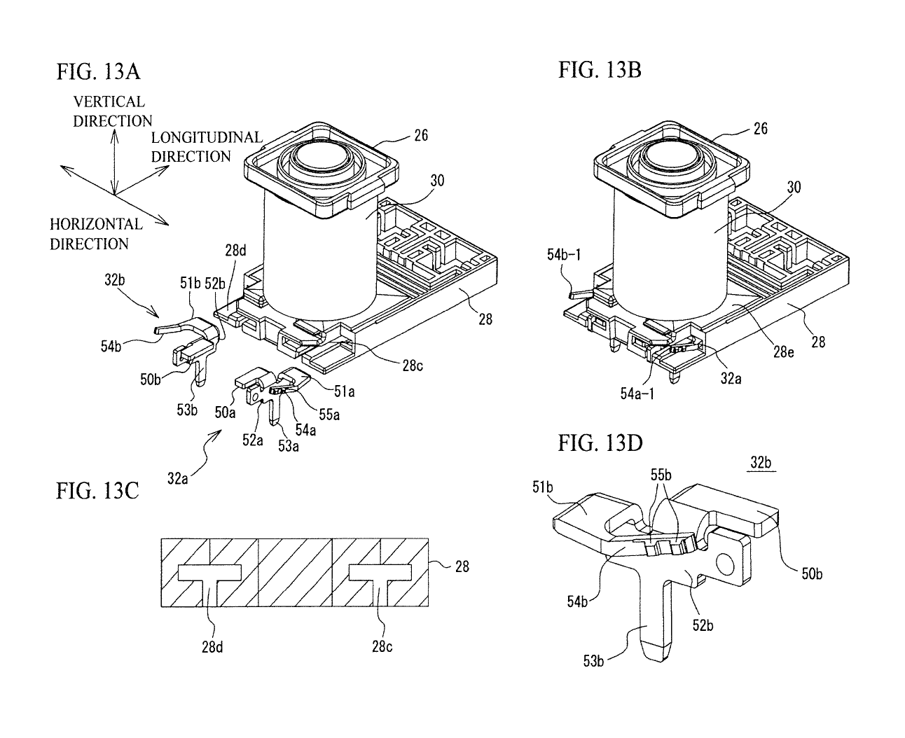

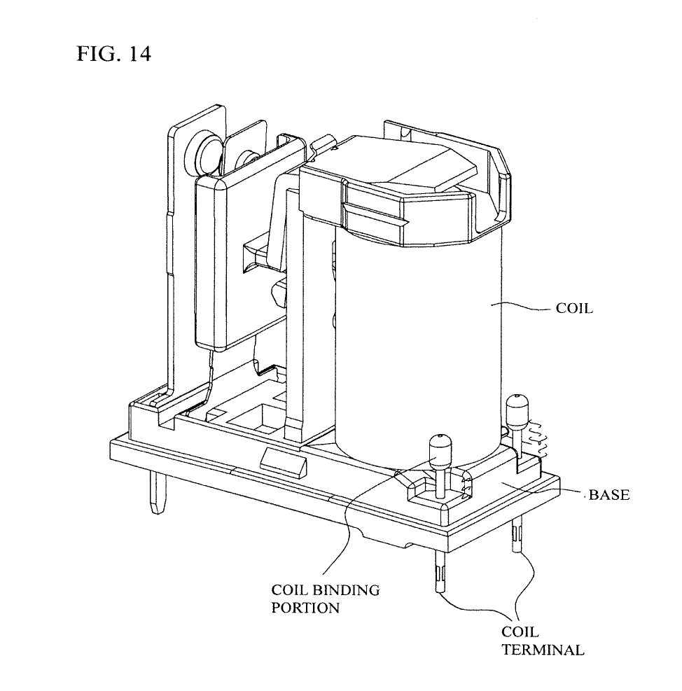

FIG. 13A is a diagram schematically illustrating the configuration of the base 28 and the pair of coil terminals 32. FIG. 13B is a diagram illustrating a state where the pair of coil terminals 32 is pressed into the base 28. FIG. 13C is a rear view of the base 28. FIG. 13D is a diagram illustrating the coil terminal 32b. Here, a side in which the pair of coil terminals 32 is press-fitted is a rear surface of the relay 1. FIG. 14 is a diagram illustrating a coil terminal mounted on a conventional relay.

As illustrated in FIG. 14, conventional coil terminals have a rod-like shape, and are press-fitted from above the base. Then, coil binding portions of the coil terminal are arranged adjacent to the coil (e.g. see a relay of Japanese Laid-open Patent Publication No. 2013-80692). Therefore, to wind the coil, the coil binding portions of the coil terminals are bent in a direction away from the coil. Then, after having finished winding the coil, the bending-back of the coil binding portions is performed to return the coil binding portions to a state illustrated in FIG. 14. However, the slack and the disconnection of the coil may occur due to the bending-back of the coil binding portions.

In coil terminals 32a and 32b of the present invention, such a bending-back of the coil binding portions is unnecessary.

The coil terminal 32a is press-fitted into a T-shaped hole 28c provided on a rear surface of the base 28 in a rear view, and the coil terminal 32b is press-fitted into a T-shaped hole 28d provided on the rear surface of the base 28 in the rear view (see FIG. 13C).

As illustrated in FIG. 13A, the coil terminal 32a is formed by bending a piece of metal plate, and includes a first horizontal portion 50a and a second horizontal portion 51a that are press-fitted into the T-shaped hole 28c and restrict the movement of the coil terminal 32a in a vertical direction, and a vertical portion 52a that restrict the movement of the coil terminal 32a in a horizontal direction. The first horizontal portion 50a and the second horizontal portion 51a are provided to invert each other horizontally from a top part of the vertical portion 52a. Moreover, the first horizontal portion 50a and the second horizontal portion 51a are provided so as to be mutually shifted in a longitudinal direction.

In addition, the coil terminal 32a extends vertically downward from the vertical portion 52a, includes: a leg portion 53a that are connected to a power supply, not shown; a coil binding portion 54a that is stood in an oblique direction from one end of the second horizontal portion 51a; and a projecting portion 55a that defines a winding position of the coil 30.

As with the coil terminal 32a, the coil terminal 32b includes: a first horizontal portion 50b and a second horizontal portion 51b that restrict the movement of the coil terminal 32b in the vertical direction; a vertical portion 52b that restricts the movement of the coil terminal 32b in a horizontal direction; a leg portion 53b that extends vertically downward from the vertical portion 52b, and is connected to the power supply, not shown; a coil binding portion 54b that is stood at a sharp angle from one end of the second horizontal portion 51b; and a projecting portion 55b that defines the winding position of the coil 30 (see FIG. 13D).

As illustrated in FIG. 13B, the base 28 does not exist at positions corresponding to the coil binding portions 54a and 54b, and the coil binding portions 54a and 54b are exposed from the base 28 in a state where the coil terminals 32a and 32b are press-fitted into the base 28. It is preferable that an edge 54a-1 of the coil binding portion 54a and an edge 54b-1 of the coil binding portion 54b are arranged at positions lower than an upper surface 28e of the base 28, as illustrated in FIG. 13B. In this case, the coil 30 can be wound around the spool 26 without considering the coil binding portions 54a and 54b.

Thus, the coil binding portions 54a and 54b are stood at the sharp angle from the horizontal portions (the second horizontal portions 51a and 51b) of the coil terminals 32a and 32b, and hence a space necessary to wind the coil 30 around the spool can be secured. According to the coil terminals 32a and 32b, the bending-back of the coil binding portions is unnecessary, and the slack and the disconnection of the coil 30 can be avoided.

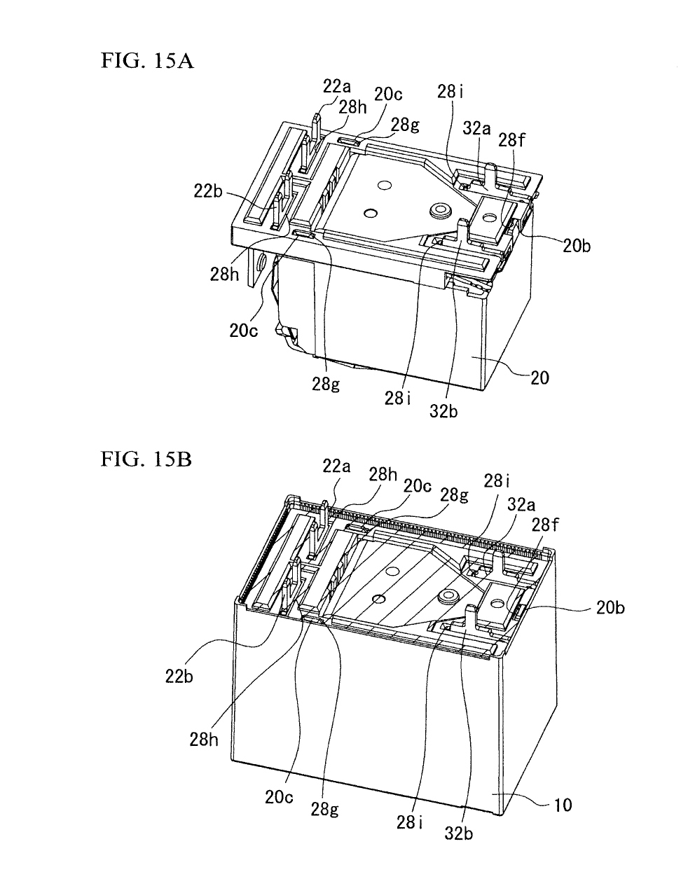

FIG. 15A is a bottom view of the relay 1 when the case 10 is not mounted. FIG. 15B is a bottom view of the relay 1 when the case 10 is mounted.

As illustrated in FIG. 15A, the base 28 includes: a recess portion 28f that engages with a projection-shaped fixing portion 20b formed on a bottom of the insulating cover 20; through-holes 28g (a first through-hole) into which projection-shaped fixing portions 20c formed on the bottom of the insulating cover 20 are inserted; through-holes 28h (a second through-hole) into which the fixed contact terminals 22a and 22b are press-fitted; and holes 28i into which the vertical portion 52a of the coil terminal 32a and the vertical portion 52b of the coil terminal 32b are press-fitted.

In the present embodiment, the fixed contact terminals 22a and 22b are press-fitted into the through-holes 28h, and the vertical portion 52a of the coil terminal 32a and the vertical portion 52b of the coil terminal 32b are press-fitted into the holes 28i. The fixing portion 20b is engaged with the recess portion 28f of the base 28, the fixing portions 20c are inserted into the through-holes 28g of the base 28, and then the case 10 is attached to the base 28 and the bottom of the base 28 is adhered with an adhesive. An oblique line portion of FIG. 15B illustrates a portion where the adhesive is applied.

In this case, in a process of adhering the fixed contact terminals 22a and 22b and the coil terminals 32a and 32b to the base 28, the insulating cover 20 can be adhered to the base 28 at the same time. Compared with a case where the process of adhering the insulating cover 20 to the base 28 and the process of adhering the fixed contact terminals 22a and 22b and the coil terminals 32a and 32b to the base 28 are performed separately, it is possible to reduce the adhering process and the manufacturing cost.

As described above, according to the above-mentioned embodiment, in the hinge type relay 1 that moves the movable contact spring 18 by rotary motion of the armature 16, the permanent magnet 12 for arc-extinguishing is arranged between the fixed contact terminal 22a and the first movable piece 18a, and the fixed contact terminal 22b and the second movable piece 18b. The fulcrums (e.g. the cutout portions 16e) of the movable member including the armature 16 and the movable contact spring 18, and the fulcrums (e.g. the lower portions 22d) of the fixed contact terminals 22a and 22b are arranged mutually in opposite directions with respect to the movable contacts 36a and 36b or the fixed contacts 38a and 38b.

Thereby, it is possible to extend the arc toward the fulcrums of the movable member, and further to extend the arc toward the fulcrums of the fixed contact terminals 22a and 22b. That is, two directions for extending the arc which are the opposite directions each other can be secured, and hence the arc can be extinguished effectively regardless of the direction of the current flowing between the contacts.

Some preferred embodiments of the present invention have been described in detail, but the present invention is not limited to these specifically described embodiments but may have various variations and alterations within the scope of the claimed invention.

1. An electromagnetic relay comprising:
a base;
a pair of fixed terminals each including a fixed contact and a first fulcrum fixed to the base;
a movable spring including a pair of movable pieces, each of the movable pieces including a movable contact contacting and separating from the fixed contact;
an armature that is coupled with the movable contact spring, and moves the movable spring by a rotary motion around a second fulcrum;
an electromagnetic device that drives the armature; and
a permanent magnet that is arranged between the pair of fixed terminals and between the pair of movable pieces, and generates a magnetic field;
wherein the first fulcrum and the second fulcrum are arranged mutually in opposite directions with respect to the movable contact or the fixed contact.

2. The electromagnetic relay according to claim 1, wherein
the fixed terminals include a first fixed contact and a second fixed contact,
the movable spring includes a first movable contact and a second movable contact, and
the electromagnetic device is arranged so that an arc generated between the first fixed contact and the first movable contact and an arc generated between the second fixed contact and the second movable contact are extended mutually in opposite directions.

3. The electromagnetic relay according to claim 2, wherein
when a direction of a current flowing between the first movable contact and the first fixed contact and between the second movable contact and the second fixed contact is a first direction, the arc generated between the first movable contact and the first fixed contact is extended in a third direction, and the arc generated between the second movable contact and the second fixed contact is extended in a fourth direction opposite to the third direction, and
when the direction of the current flowing between the first movable contact and the first fixed contact and between the second movable contact and the second fixed contact is a second direction opposite to the first direction, the arc generated between the first movable contact and the first fixed contact is extended in the fourth direction, and the arc generated between the second movable contact and the second fixed contact is extended in the third direction.

4. The electromagnetic relay according to claim 1, wherein
each of the pair of movable pieces includes an upper portion, and a lower portion on which the movable contact is mounted and that is bent from the upper portion away from the fixed contact opposite to the movable contact.

5. The electromagnetic relay according to claim 4, wherein
each of the pair of movable pieces further includes a lowest portion that is bent from the lower portion.

6. The electromagnetic relay according to claim 5, wherein
each of the pair of movable pieces includes a first cut-and-raised portion that projects toward the movable contact from the lowest portion.

7. The electromagnetic relay according to claim 4, wherein
each of the pair of movable pieces includes a second cut-and-raised portion that projects toward the movable contact from the upper portion.

8. The electromagnetic relay according to claim 1, wherein
each of the pair of fixed terminals includes a second upper portion on which the fixed contact is mounted, and an uppermost portion that is arranged above the fixed contact and is bent in a direction away from the movable spring.

9. The electromagnetic relay according to claim 8, wherein
each of the pair of fixed terminals includes a third cut-and-raised portion that projects toward the fixed contact from the uppermost portion.

10. The electromagnetic relay according to claim 1, further comprising:
an insulating cover that covers the electromagnetic device and a part of the base, and include a first uneven portion and a second uneven portion,
wherein the electromagnetic device includes a third uneven portion opposite to the first uneven portion of the insulating cover,
the base includes a fourth uneven portion opposite to the second uneven portion of the insulating cover, and
when the insulating cover is mounted on the base, the first uneven portion and the second uneven portion are fitted into the third uneven portion and the fourth uneven portion, respectively.

11. The electromagnetic relay according to claim 1, wherein
the base includes a fifth uneven portion between the pair of fixed terminals.

12. The electromagnetic relay according to claim 10, comprising:
a stopper that is formed integrally with the insulating cover, and contacts the movable spring when the electromagnetic device is turned off.

13. The electromagnetic relay according to claim 1, comprising:
a coil terminal electrically connected to a coil included in the electromagnetic device,
wherein the coil terminal includes a coil binding portion exposed from the base in a state where the coil terminal is press-fitted into the base,
the coil binding portion is stood at a sharp angle from a horizontal portion of the coil terminal.

14. The electromagnetic relay according to claim 13, wherein
an edge of the coil binding portion is arranged lower than an upper surface of the base.

15. The electromagnetic relay according to claim 13, wherein
the insulating cover includes a plurality of fixing portions to fix the insulating cover to the base,
the base includes a recess portion that engages with a first fixing portion among the plurality of fixing portions, a first through-hole into which a second fixing portion among the plurality of fixing portions is inserted, a second through-hole into which the pair of fixed contact terminals is press-fitted, and a hole into which the coil terminal is press-fitted, and
the plurality of fixing portions, the pair of fixed son-tact-terminals and the coil terminal are collectively fixed to the base by adhering an adhesive to the bottom of the base.

16. A coil terminal formed by bending a piece of metal plate, comprising:
a vertical portion that restricts the movement of the coil terminal in a horizontal direction;
a horizontal portion that restricts the movement of the coil terminal in a vertical direction;
a leg portion that extends vertically downward from the vertical portion, and is connected to a power supply; and
a coil binding portion that is stood obliquely from one end of the horizontal portion, and around which a coil is wound.
